(19) United States
(12) Patent Application Publication
(10) Pub. No.: US 2017/0332746 A1
(43) Pub. Date: Nov. 23, 2017

(54) RING SIZING SYSTEM

(71) Applicant: KRAINZ CREATIONS, INC., New York, NY (US)

(72) Inventor: Roland KRAINZ, Brookfield, CT (US)

(21) Appl. No.: 15/599,897

(22) Filed: May 19, 2017

Related U.S. Application Data
(60) Provisional application No. 62/339,146, filed on May 20, 2016.

(51) Int. Cl. A44C 9/02; A44C 9/00; G01B 3/34

(52) U.S. Cl. CPC A44C 9/02; A44C 9/0023; A44C 9/0007; A44C 9/0015; G01B 3/34

(57) ABSTRACT

A jewelry ring sizing system is disclosed that has an outer jewelry ring, an endless elastomeric ring, and an inner endless ring press-fit within the outer jewelry ring in a concentric orientation relative thereto with the endless elastomeric ring encapsulated between the outer jewelry ring and the inner endless ring.

### RELATED APPLICATIONS

This Application claims the benefit of U.S. Provisional Application No. 62/339,146, filed May 20, 2017, the entire contents of which are incorporated herein by reference.

### TECHNICAL FIELD

The present application relates generally to jewelry and, more particularly, to a ring sizing system with a toroidal elastomeric spring element encapsulated between an outer jewelry ring and an inner endless ring.

### BACKGROUND

A common problem with jewelry, particularly rings, is that the size of the human hand can fluctuate from a variety of factors ranging from extremely cold weather or warm weather to weight gain. Thus, a ring that has a diameter of 15 mm may fit comfortably one day, but can become uncomfortably tight or loose the next. This is particularly undesirable for rings as certain rings, such as engagement or wedding rings, are worn every day.

While a person can have a ring resized by a jeweler, such a solution is not practical. First, it is inconvenient to require a person to schedule time to resize jewelry. Second, there is a risk that, upon resizing, imperfections are introduced into the metal comprising the jewelry. Therefore, a system is sought where a person can wear a ring comfortably despite common changes in finger size.

For example, U.S. Pat. No. 7,845,191 to Czajka discloses an adjustable ring having a ring shaped frame that includes a channel or groove region into which movable segments can be placed. However, Czajka teaches a plurality of size adjustment segments, smaller non-annular pieces that can easily become lost. U.S. Pat. Nos. 3,460,355 and 3,460,356, both to Lodrini, also disclose an adjustable ring wherein the inner, auxiliary band is non-annular and comprises multiple pieces, thereby creating possible pinch points for the skin of the wearer.

Accordingly, an adjustable ring sizing system is desired to provide a person the ability to comfortably wear a ring despite internal physiological changes or external temperature changes causing a person's finger to increase or decrease in diameter, and to provide jewelers a fast and easy way to change the size of a jewelry ring so that a customer can leave the shop the same day with a ring that fits, especially a ring that looks complete and has no pinch points for the wearer's skin. The ring sizing system disclosed herein meets these needs and solves the problems of the prior art ring sizing systems.

### SUMMARY

A jewelry ring sizing system is disclosed that has an outer jewelry ring, an endless elastomeric ring, and an inner endless ring press-fit within the outer jewelry ring in a concentric orientation relative thereto with the endless elastomeric ring encapsulated between the outer jewelry ring and the inner endless ring that thereby defines a jewelry ring. The outer jewelry ring has a first annular groove in an interior surface thereof oriented to be concentric relative to the inner endless ring. In one embodiment, the inner endless ring reduces a ring size of the outer jewelry ring by one size.

In all aspects, the first annular groove is generally centrally positioned within the interior surface of the outer jewelry ring, and the inner endless ring has a second annular groove in an exterior surface thereof facing the first annular groove of the outer jewelry ring to collectively define a cavity for the endless elastomeric ring. The diameter of the cavity is less than the diameter of the endless elastomeric ring before encapsulation between the outer jewelry ring and the inner endless ring, and the first annular groove is either deeper than the second annular groove or has the same depth. The interior surface of the outer jewelry ring further has a first annular surface and a second annular surface on opposing sides of the first annular groove, and the exterior surface of the inner endless ring further comprises a third annular surface and a fourth annular surface on opposing sides of the second annular groove, wherein the first and second annular surfaces are mated to the third and fourth annular surfaces.

In all aspects, the inner endless ring and the outer jewelry ring are of generally equal axial width, thereby collectively defining a front face and a back face of the jewelry ring, the endless elastomeric ring has a toroidal-shape, and each of the third and fourth annular surfaces has an annular ridge proximate the second annular groove. The annular ridge defines the greatest outer diameter of the inner annular ring, and the third and fourth annular surfaces gradually taper from the annular ridge axially outward away from the second annular groove to define a smaller outer diameter most distal the second annular groove.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present system.

FIG. 1 is a an exploded, perspective view of a jewelry ring sizing system.

FIG. 2 is a back, plan view of an assembled jewelry ring from the jewelry ring sizing system of FIG. 1.

FIG. 3 is a side view of the inner endless ring of the jewelry ring sizing system of FIG. 1.

FIG. 4 is a top, plan view of the jewelry ring sizing system of FIG. 2 with the top half of the outer jewelry ring removed to reveal the elastomeric spring element, with no inner ring present.

FIG. 5 is a cross-section of the jewelry ring sizing system of FIG. 2 taken in a plane transverse to the direction of insertion onto a wearer's finger.

FIG. 6 is a cross-section of the jewelry ring sizing system of FIG. 2 taken along line 6-6.

### DETAILED DESCRIPTION

The following detailed description will illustrate the general principles of the invention, examples of which are additionally illustrated in the accompanying drawings. In the drawings, like reference numbers indicate identical or functionally similar elements.

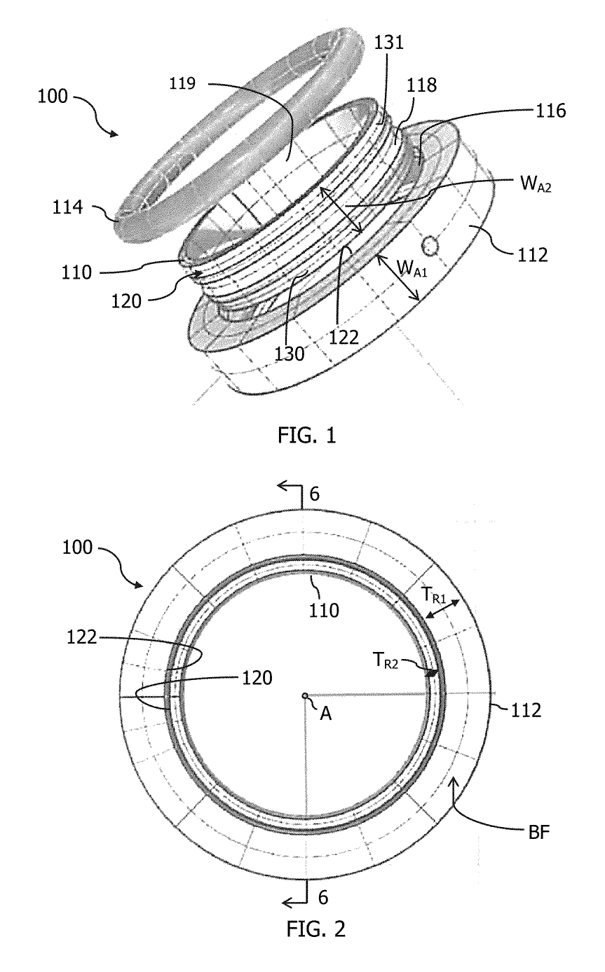

Referring now to FIG. 1, a jewelry ring sizing system, generally referenced by reference number 100, is shown in an unassembled state as having an inner ring 110, an outer jewelry ring 112, and an elastomeric ring 114. Each of these rings 110, 112, 114 are endless rings. Once assembled, the inner endless ring 110 is press-fit within the outer jewelry ring 112 in a concentric orientation relative thereto with the endless elastomeric ring 114 encapsulated between the outer jewelry ring 112 and the inner endless ring 110 as shown in FIGS. 2 and 4-6 in compression therebetween, so that the press-fit holds the inner and outer rings 110, 112 together. The addition of the inner endless ring 110 typically reduces the size of the outer jewelry ring 112 by one size, but could be dimensioned to reduce the size by a half size, one and a half sizes or two sizes. The use of endless rings 110, 112, and 114 provides the benefit of eliminating any possible junction(s) of material that could form a pinch point for the wearer's skin. Also, the encapsulation of the endless elastomeric ring 114 provides a quality appearance to the jewelry ring by hiding this component from the wearer's and an observer's eye.

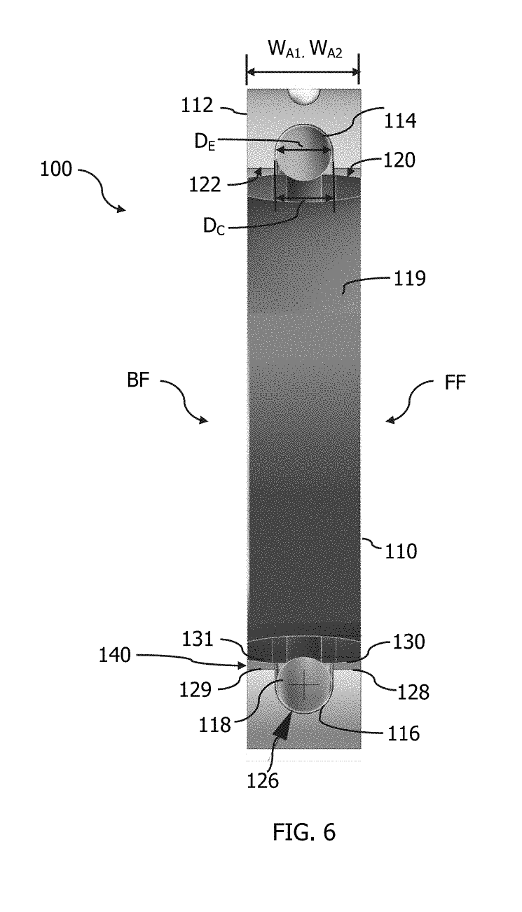

Referring to FIGS. 1-2 and 4-6, the outer jewelry ring 112 may be a plain band or a decorated band of any design that may include a gem or stone. Regardless of the ornamental exterior of the outer jewelry ring 112, this ring has a first annular groove 116 in an interior surface 122 thereof, which is best seen in FIG. 6. The first annular groove 116 is oriented to be concentric relative to the inner endless ring 110 and may be generally centrally positioned within the interior surface 122. The interior surface 122 has a first annular surface 128 and a second annular surface 129 on opposing sides of the first annular groove 116. The first and second annular surfaces 128, 129 are generally vertical, smooth surfaces that are parallel to the central axis A (FIG. 2) (relative to the orientation of the illustrated drawing to the page) of the assembled jewelry ring when viewed in the cross-section taken along line 6-6 as shown in FIG. 6. The outer jewelry ring 112 has a radial thickness T_{R1} as labeled in FIGS. 2 and 4, which must be greater than the depth of the first annular groove 116, which is labeled as T_{G} in FIG. 4. The depth T_{G} of the first annular groove 116 has a ratio to the radial thickness T_{R1} of the outer jewelry ring 112 in the range of 1:1.5 to 1:2, more preferably 1:1.6 to 1:1.8.

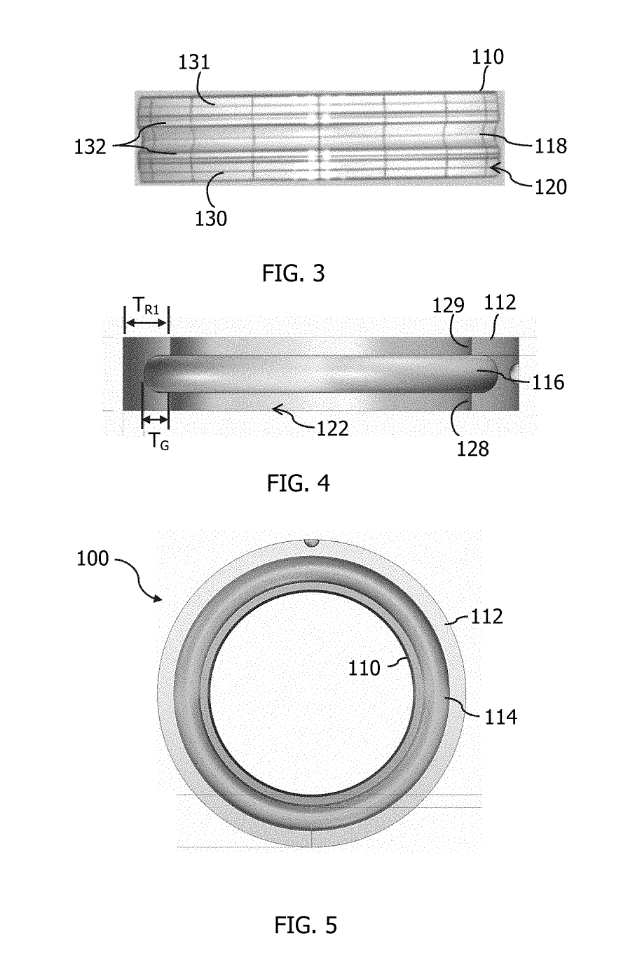

Referring now to FIGS. 1-3 and 5-6, the inner endless ring 112 typically has a plain band with a smooth interior surface 119 because this surface contacts the finger of the wearer. The outer or exterior surface 120, opposite the interior surface 119, has a second annular groove 118 facing the first annular groove 116 of the outer jewelry ring 112 to collectively define a cavity 126 (FIG. 6) for the endless elastomeric ring 114. The exterior surface 120 of the inner endless ring 110 has a third annular surface 130 and a fourth annular surface 131 on opposing sides of the second annular groove 118. Each of the third and fourth annular surfaces 130, 131 has an annular ridge 132 proximate the second annular groove 118. The annular ridges 132 define the greatest outer diameter of the inner annular ring 110, and the exterior surface 120 defined by each of the third and fourth annular surfaces 130, 131 gradually tapers from the annular ridge 132 axially outward away from the second annular groove 118 to define a smaller outer diameter most distal the second annular groove 118. This is a smooth, continuous transition without any stair stepping or shoulders. As best illustrated in FIG. 6, the inner endless ring 110 has a bi-convex profile for the opposing interior surface 119 and exterior surface 120 when viewed as a longitudinal cross-section.

With reference to FIGS. 1-2 and 6, the first and second annular surfaces 128, 129 of the outer jewelry ring 112 are facing the third and fourth annular surfaces 130, 131 of the inner endless ring 110, respectively, in the assembled state with a small gap 140 (FIG. 6) therebetween defined by the endless elastomeric ring. The inner endless ring 110 and the outer jewelry ring 112 are of generally equal axial width W_{A1} and W_{A2}, thereby collectively defining a front face FF and a back face BF of the jewelry ring. This small gap 140 at the front face FF and the back face BF is at most equivalent to half the radial thickness T_{R2} of the inner endless ring 110, but is preferably less. The radial thickness T_{R1} of the outer jewelry ring is greater than the radial thickness T_{R2} of the inner endless band. The radial thickness T_{R2} of the inner endless ring 110 is about 0.4 mm to about 1 mm and has a ratio to the radial thickness T_{R1} of the outer jewelry ring 112 (for the band portion thereof, i.e., not including any protruding settings for gems or stones) in a range of 1:3.5 to 1:5, more preferably about 1:4 to 1:4.5.

The diameter D_{C} of the cavity 126 is less than the diameter D_{E} of the endless elastomeric ring 114 before encapsulation between the outer jewelry ring 112 and the inner endless ring 110. Accordingly, the endless elastomeric ring 114 is placed in compression when encapsulated therebetween. The first annular groove 116 is deeper than the second annular groove 118. The ratio of the depth of the first annular groove 116 to the depth T_{G} of the second annular groove 118 is in a range of about 1:13 to about 1:17.5, more preferably about 1:14 to about 1:15.

The endless elastomeric ring 114 is preferably toroidal-shaped, but is not limited thereto. The endless elastomeric ring 114 is made of an elastomeric material, such as a natural rubber or synthetic rubber, but is not limited thereto. The endless elastomeric ring 114 has a diameter in the range of about 1 mm to about 2 mm in the unassembled state.

The method of assembly includes inserting the inner endless ring 110 inside the outer jewelry ring 112 as a press-fit with an endless elastomeric ring 114 encapsulated therebetween. The endless elastomeric ring 114 is seated within an appropriately shaped groove 116 in the outer jewelry ring 112 and an appropriately shaped groove 118 in the endless inner ring 110, so that it is encapsulated therebetween. The outer jewelry ring 112, as such, includes a generally rounded annular groove 116 when viewed in a longitudinal cross-section (as shown in FIG. 6). In the method of assembly, the method may include seating the endless elastomeric ring 114 in either of the first annular groove 116 or the second annular groove 118 before press-fitting the inner endless ring 110 into the outer jewelry ring 112.

In the assembled state, the inner endless ring 110 does not sit within a channel or groove in the outer jewelry ring 112. Instead, the inner endless ring's third and fourth annular surfaces 130, 131, that define the second annular groove 118, are generally proximate the first and second annular surfaces 128, 129 of the jewelry ring 112, that define the first annular groove 116, but are spaced a distance therefrom as a result of the presence of the endless elastomeric ring 114, thereby defining a small gap 140 at least at the front face FF and the back face BF of the assembled jewelry ring.

Although various aspects of the disclosed ring sizing system have been shown and described, modifications may become apparent to those skilled in the art upon reading the specification. The present application includes such modifications and is limited only by the scope of the claims.

What is claimed is:

1. A jewelry ring sizing system, comprising:
an outer jewelry ring;
an endless elastomeric ring; and
an inner endless ring press-fit within the outer jewelry ring in a concentric orientation relative thereto with the endless elastomeric ring encapsulated between the outer jewelry ring and the inner endless ring.

2. The jewelry ring sizing system of claim 1, wherein the outer jewelry ring has a first annular groove in an interior surface thereof oriented to be concentric relative to the inner endless ring.

3. The jewelry ring sizing system of claim 2, wherein the first annular groove is generally centrally positioned within the interior surface of the outer jewelry ring.

4. The jewelry ring sizing system of claim 2, wherein the inner endless ring has a second annular groove in an exterior surface thereof facing the first annular groove of the outer jewelry ring to collectively define a cavity for the endless elastomeric ring.

5. The jewelry ring sizing system of claim 4, wherein the diameter of the cavity is less than the diameter of the endless elastomeric ring before encapsulation between the outer jewelry ring and the inner endless ring.

6. The jewelry ring sizing system of claim 4, wherein the first annular groove is deeper than the second annular groove.

7. The jewelry ring sizing system of claim 4, wherein the first annular groove and the second annular groove have the same depth.

8. The jewelry ring sizing system of claim 4, wherein the interior surface of the outer jewelry ring further comprises a first annular surface and a second annular surface on opposing sides of the first annular groove, and the exterior surface of the inner endless ring further comprises a third annular surface and a fourth annular surface on opposing sides of the second annular groove, wherein the first and second annular surfaces are mated to the third and fourth annular surfaces.

9. The jewelry ring sizing system of claim 1, wherein the inner endless ring and the outer jewelry ring are of generally equal axial width, thereby collectively defining a front face and a back face of the jewelry ring.

10. The jewelry ring sizing system of claim 1, wherein the endless elastomeric ring has a toroidal-shape.

11. The jewelry ring sizing system of claim 8, wherein each of the third and fourth annular surfaces has an annular ridge proximate the second annular groove, the annular ridge defining the greatest outer diameter of the inner annular ring, and gradually tapering from the annular ridge axially outward away from the second annular groove to define a smaller outer diameter most distal the second annular groove.

12. The jewelry ring sizing system of claim 11, wherein the inner endless ring reduces a ring size of the outer jewelry ring by one size.
